(19) United States
(12) Patent Application Publication
(10) Pub. No.: US 2006/0212141 A1
(43) Pub. Date: Sep. 21, 2006

(54) Radio frequency identification-detect ranking system and method of operating the same

(76) Inventors: Thomas C. Abraham JR., Dallas, TX (US); Balaraju Velupula, Coppell, TX (US); Matthew D. Wilson, McKinney, TX (US)

Correspondence Address: SLATER & MATSIL, L.L.P., 17950 PRESTON RD, SUITE 1000, DALLAS, TX, 75252-5793, US

(21) Appl. No.: 11/361,188

(22) Filed: Feb. 24, 2006

Related U.S. Application Data
(60) Provisional application No. 60/656,344, filed on Feb. 25, 2005.

(51) Int. Cl. G05B 13/02; G06F 17/50; G06F 17/10; G06F 9/455; G01N 37/00; G08B 13/14; G06F 7/00

(52) U.S. Cl. 700/30; 703/13; 702/81; 703/2; 703/23; 340/572.1; 700/225

(57) ABSTRACT

A radio frequency identification (RFID)-detect ranking system and method of operating the same. In one embodiment, the RFID-detect ranking system includes a matrix subsystem configured to construct a matrix of experiments based on product information, RFID reader information and RFID tag information. The RFID-detect ranking system also includes a data collection subsystem configured to facilitate an experiment and collect data to fill in results for each category of the matrix of experiments. The RFID-detect ranking system still further includes a ranking subsystem configured to assign an index based on the results for each category of the matrix of experiments, thereby providing a likelihood of success of reading an RFID tag located on a product with an RFID reader.

This application claims the benefit of U.S. Provisional Application No. 60/656,344, entitled “Automated RFID Calibration Tool,” filed on Feb. 25, 2005, which is incorporated herein by reference.

### TECHNICAL FIELD

The present invention is directed, in general, to radio frequency identification (“RFID”) testing systems and, in particular, to an RFID-detect ranking system and method of operating the same.

### BACKGROUND

While the core technologies that support radio frequency identification (“RFID”) systems have been around for some time, the applications that drive the use thereof have been slow to market. The aforementioned trend has been turning in an impressive fashion as the size and cost of the RFID tags has decreased and the sensitivity of the RFID readers has increased. Moreover, the market forces, especially with respect to the supply chain in the retail industry, are pulling the RFID technologies into the mainstream and literally on to the shelves.

As the market experiences the growing pains associated with the application of any new technology, the initial testing of the RFID technologies in accordance with products has lead to many shortcomings, which impact the utility of the RFID tags on the products. In accordance therewith, many of the limitations relate to human factors that include designing meaningful experiments to isolate desired information and setting up the experiments as designed. Other human factor limitations include capturing trial data reliably, efficiently and cost effectively, and measuring a quality or RFID friendliness of the captured data. Once the data is captured and measured, the reporting and application of the data to enhance the supply chain systems has also been lacking.

The conventional attempts to perform the trials included manual data capture and manual data manipulation to yield the appropriate feedback. Typically, testers record the data visually from a demonstration software package on to a spreadsheet, which has the shortcomings of quick flashes of critical data values followed by large amounts of data of little value. Literally, one blink could cause a critical piece of information to be overlooked, thereby skewing the data set. Additionally, performing data capture manually with a spreadsheet and using personnel is unreliable, and the manual system requires adequate and often substantial personnel training to ensure that the operating results are consistent. Furthermore, with the dawn of the EPCGlobal standards and related publications (see, EPCglobal release EPC Specification for Class 1 Gen 2 RFID Specification, Dec. 2004, and a “Whitepaper: EPCglobal Class 1 Gen 2 RFID Specification,” published by Alien Technology Corporation, Morgan Hill, Calif. (2005), both of which are incorporated herein by reference), and the union of retail distribution RFID adoption, the need for tens of thousands of product tests drives a demand for fast, reliable, consistent, and efficient testing and reporting tools.

Additionally, unlike conventional reader systems employing barcodes, the proper placement of an RFID tag is important to the successful RFID deployment in the supply chain. The accuracy of the RFID readers under widely varying conditions becomes a key to successful RFID deployment. Different placements and types of RFID tags substantially affect the readability and performance thereof. The overall process of determining the best readability and performance of the RFID system is often referred to as RFID engineering.

As alluded to above, RFID engineering has been a manual process to date that includes many hours of data collection and manipulation. The manual process encompasses manually recording the data (i.e., keyed into a spreadsheet) for every distinctive variation of an experiment. As experiments were repeated for new customers as well as existing customers, it became apparent that human error was causing a great deal of discrepancy with regard to the data that was being collected. Human data collection also leads to a secondary problem of too much time being spent on each experiment, resulting in lower throughput, which is unacceptable in view of the increasing number of customer compliance deadlines.

Another variable is that new hardware, new RFID tags, new RFID readers, and new antennas are constantly being released that impact RFID engineering. Additionally, consideration of other variables such as environmental conditions, conveyor designs (including different speeds of operation), and antenna portal designs contribute to the complexity of the RFID engineering. Therefore, a dynamic system that can accommodate the improved models with configuration as opposed to recoding thereof would be advantageous.

Accordingly, what is needed in the art is a system and method that analyzes the parameters that affect the utilization of RFID technologies in applications such as supply chain systems in the retail industry and to provide meaningful reporting that further augments the proliferation of RFID technologies in many diverse markets and industries.

### SUMMARY OF THE INVENTION

These and other problems are generally solved or circumvented, and technical advantages are generally achieved, by advantageous embodiments of the present invention that include a radio frequency identification (RFID)-detect ranking system and method of operating the same. In one embodiment, the RFID-detect ranking system includes a matrix subsystem configured to construct a matrix of experiments based on product information, RFID reader information and RFID tag information. The RFID-detect ranking system also includes a data collection subsystem configured to facilitate an experiment and collect data to fill in results for each category of the matrix of experiments. The RFID-detect ranking system still further includes a ranking subsystem configured to assign an index based on the results for each category of the matrix of experiments, thereby providing a likelihood of success of reading an RFID tag located on a product with an RFID reader.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a system level diagram of an embodiment of an RFID testing system constructed according to the principles of the present invention;

FIG. 2 illustrates a block diagram of an embodiment of an RFID-detect ranking system constructed according to the principles of the present invention;

FIGS. 3 to 5 illustrate screen shots demonstrating a method of ranking a likelihood of success of reading RFID tags on a product in accordance with the principles of the present invention; and

FIGS. 6 to 61 illustrate screen shots demonstrating a setup, design of experiments, experiment trials and reporting associated with an embodiment of an RFID-detect ranking system in accordance with the principles of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention. Unless otherwise provided, like designators for devices employed in different embodiments illustrated and described herein do not necessarily mean that the similarly designated devices are constructed in the same manner or operate in the same way.

The present invention will be described with respect to an exemplary embodiment in a specific context, namely, an RFID-detect ranking system. The particular embodiment described herein is applied to a supply chain application in the retail industry. The principles of the present invention may be applied to other applications and industries such as the defense industry and healthcare market.

The RFID-detect ranking system expands and extends design of experiments methodologies such as provided by Taguchi to design meaningful experiments based on elemental variable criteria directed to product information (e.g., casing dimensions), RFID tag information (e.g., types, orientations, positions) and RFID reader information (e.g., types, antenna configuration). For more information on methodologies by Taguchi, see “Design of Experiments Using the Taguchi Approach: 16 Steps to Product and Process Improvement,” by Ranjit K. Roy, published by John Wiley & Sons, Ltd, February 2001, which is incorporated herein by reference. Furthermore, the RFID-detect ranking system facilitates the automation of the data capture process via integration with hardware tools used in the experiments. The integration (e.g., software) substantially eliminates the introduction of human error to the experiment and, in addition, makes the testing process scalable and efficient. Additionally, the RFID-detect ranking system may provide automatic data capture for automatic data reporting. As a result, the RFID-detect ranking system produces meaningful structured graphical statistics captured throughout the automatic trial processes of the likelihood of success (e.g., probabilities) of reading an RFID tag located on a product (e.g., at a specific location and orientation) with an RFID reader.

The RFID-detect ranking system is a dynamic system that can accommodate improved models with configuration as opposed to recoding thereof. The RFID-detect ranking system is a tool that collects structured data from an RFID reader, stores the data systematically and categorically, and then automatically evaluates and reports the results. The RFID-detect ranking system can accommodate new RFID tags, new RFID readers, and other considerations such as environmental conditions, conveyor designs (including different speeds of operation), and antenna portal designs that contribute to the complexity of RFID engineering. The RFID-detect ranking system is adaptable of not only accommodating the variables described above, but can handle new tests that may exponentially increase the complexity of a matrix embodying the tests. As an example, the addition of one variable in the RFID experiment (such as changing an RFID tag orientation) leads to the creation of two new experiments. The RFID-detect ranking system quickly, directly, and seamlessly addresses the new dynamics in the RFID engineering process.

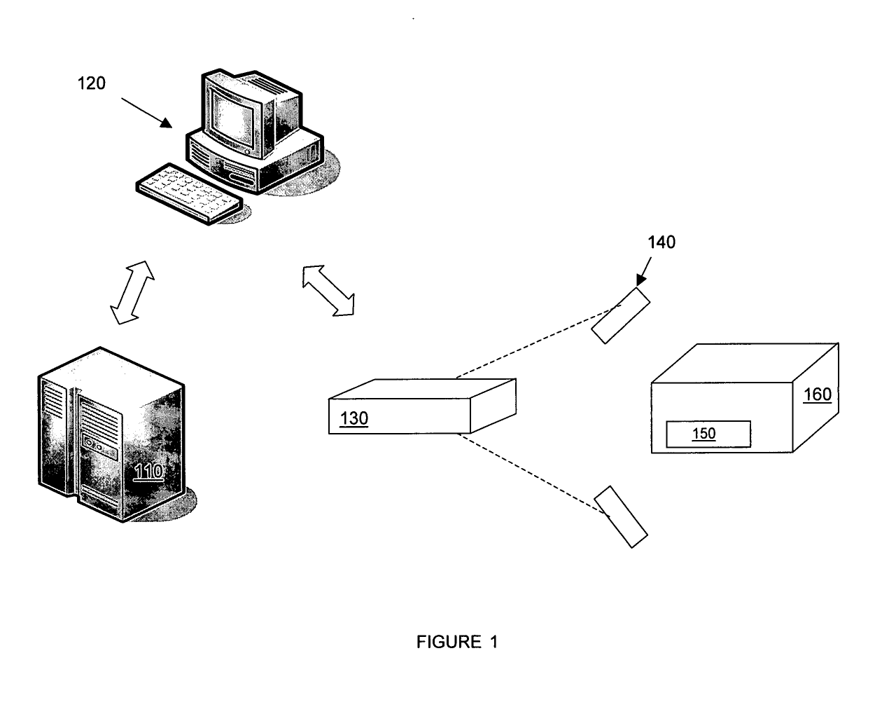

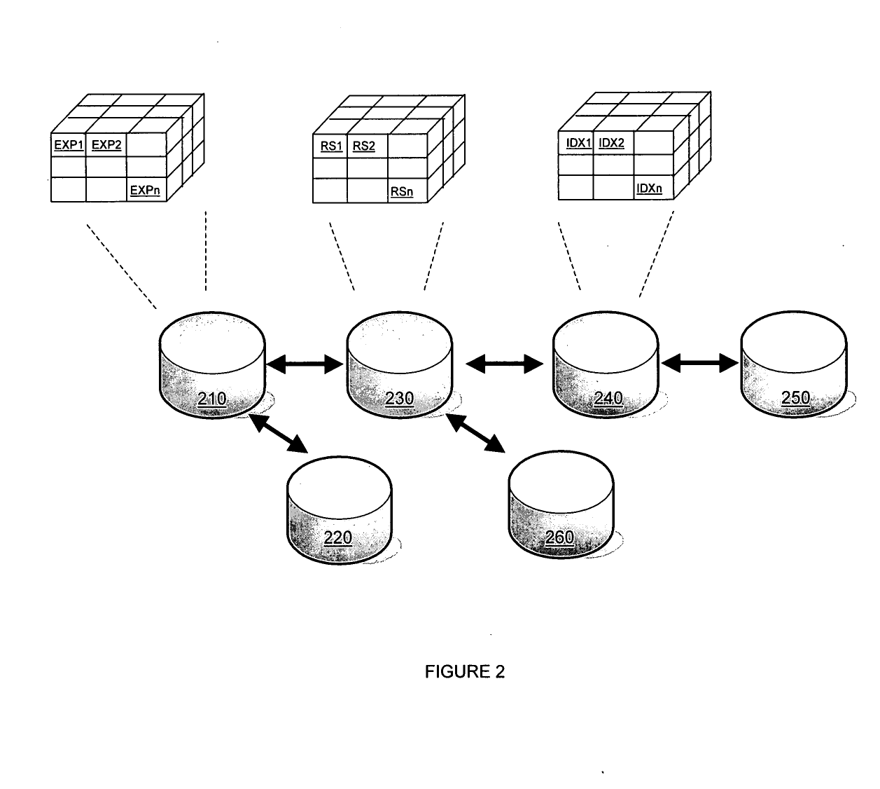

Referring initially to FIG. 1, illustrated is a system level diagram of an embodiment of an RFID testing system constructed according to the principles of the present invention. The RFID testing system includes an RFID-detect ranking system (referred to as “XCaliper™”), of which an embodiment thereof is illustrated and described with respect to FIG. 2. The RFID testing system generally provides an RFID engineering tool that facilitates the proper RFID design, testing, and execution methodology to ensure reliable RFID solutions via RFID equipment selection, RFID equipment settings, environmental conditions, and product performance.

The RFID testing system of FIG. 1 includes a server 110, a computer system 120, and an RFID reader 130 with antennas (one of which is designated 140). The RFID-detect ranking system is generally resident on the computer system 120 (in connection with the server 110) and directs the RFID reader 130 to read RFID tag(s) 150 located on a product 160. While a single product 160 is illustrated herein, those skilled in the art should understand that the product conceptually may also represent, without limitation, a case, a pallet, a container, and a truckload of product(s). In addition, the communication links between respective systems in the RFID testing system may be wired or wireless communication paths to facilitate the transmission of information therebetween. For a better understanding of communication theory, see the following references “Introduction to Spread Spectrum Communications,” by Roger L. Peterson, et al., Prentice Hall, Inc. (1995), “Modern Communications and Spread Spectrum,” by George R. Cooper, et al., McGraw-Hill Books, Inc. (1986), “An Introduction to Statistical Communication Theory,” by John B. Thomas, published by John Wiley & Sons, Ltd. (1995), “Wireless Communications, Principles and Practice,” by Theodore S. Rappaport, published by Prentice Hall, Inc. (1996), “The Comprehensive Guide to Wireless Technologies,” by Lawrence Harte, et al., published by APDG Publishing (1998), “Introduction to Wireless Local Loop,” by William Webb, published by Artech Home Publishers (1998) and “The Mobile Communications Handbook,” by Jerry D. Gibson, published by CRC Press in cooperation with IEEE Press (1996), all of which are incorporated herein by reference.

The RFID testing system in conjunction with the RFID-detect ranking system is an RFID application that enables operators/users to quickly create and track meaningful RFID experiments when testing, for instance, RFID reader(s) 130, RFID tag(s) 150, operating environments and any product(s) 160. The solution design of the RFID testing system accommodates any RFID reader, any RFID tag, and any product for RFID testing and the engineering in any unit of measure (e.g., at the pallet level).

The RFID-detect ranking system automatically interfaces to the RFID reader(s) 130 for setting reading parameters thereof as well as automatic data capture. The RFID reader(s) 130 communicate with the RFID tag(s) 150 by themselves or applied to any object such as a product 160 that the user finds of interest from an RFID perspective. Once the data is captured, the RFID-detect ranking system processes the data and provides an index (referred to as the “XFactor™”) to rank the RFID hardware including the RFID reader(s) 130, RFID tag(s) 150, product(s) 160 and the associated settings, etc. for a likelihood of success (e.g., probability) of reading the RFID tag(s) 150 in a selected operating environment. The index is generated for each iteration of experiment created by the RFID-detect ranking system and provides a reliable indicator of RFID performance in any operating environment.

Turning now to FIG. 2, illustrated is a block diagram of an embodiment of an RFID-detect ranking system constructed according to the principles of the present invention. As mentioned above, the RFID-detect ranking system may reside on any computer system (and, without limitation, any associated server or database) adapted to communicate with an RFID reader. The RFID-detect ranking system may be integrated into a single computer system or separated into modules resident in a distributed computer system as the application dictates.

The RFID-detect ranking system includes a matrix subsystem 210 configured to construct a matrix of experiments (represented by a matrix with designations EXP1, EXP2, . . . EXPn) based on product information, RFID reader information and RFID tag information. The product information includes, without limitation, any type of product, product configuration, and product make-up (e.g., density and construction materials). The RFID reader information includes information such as the type and design of the RFID reader, the sensitivity of the RFID reader and the configuration of the RFID reader including the corresponding antenna design employed to interrogate an RFID tag. The RFID tag information includes information such as the type and design of the RFID tag, the configuration of the RFID tag, the orientation of the RFID tag, the placement position of the RFID tag and read range of the RFID tag.

The product information, the RFID reader information and the RFID tag information may be stored within a database 220. Of course, the database 220 may store other information associated with the RFID-detect ranking system. The criteria that the user may find of interest is not limited to any preset number or set of characteristics, but it is configurable and adaptable to accommodate, without limitation, any RFID tag, any product position, any RFID reader, or any operational environmental consideration. These characteristics are configured into an orthogonal array in the matrix subsystem 210. To create the full design of experiments, for all variants of the matrix, the matrix subsystem 210 multiplies all the orthogonal array values in a database. For example, if a user wanted to test two RFID tags in two positions with two different orientations, then the matrix subsystem 210 would produce eight experiments (2×2×2). In addition, even though selected subsystems and modules are illustrated as connected by arrows in the FIGUREs, it should be understood that the subsystems and modules within the RFID-detect ranking system are coupled together, either directly or indirectly.

The RFID-detect ranking system also includes a data collection subsystem 230 configured to facilitate an experiment (preferably, a plurality of experiments) and collect data to fill in the results (represented by a matrix with designations RS1, RS2, . . . RSn) for each category of the matrix of experiments. The data collection subsystem 230 gathers all the RFID read data from the reader along with the settings of the experiment components for documentation and potential repeatability of the experiment; these data are stored in the database. The RFID-detect ranking system still further includes a ranking subsystem 240 (also referred to as “XFactor™”) configured to assign an index (represented by a matrix with designations IDX1, IDX2, . . . IDXn) based on the trial results for each category of the matrix of experiments. The index is calculated via an algorithm in the ranking subsystem 240 and provides a likelihood of success (e.g., probability) of reading an RFID tag located on a product with an RFID reader for each specific experiment.

The RFID-detect ranking system also includes a reporting module 250 configured to provide a report to display the index for each category of the matrix of experiments in an easy-to-read format (i.e., a user-friendly format) such as a graphical representation. The reporting module 250 can provide different values based on the type of experiment being performed with the different products and other parameters. The RFID-detect ranking system still further includes a calibration subsystem 260 configured to set or calibrate reading parameters of the RFID readers. Thus, the calibration subsystem 260 may operate in conjunction with the data collection subsystem 230 to facilitate an experiment. The calibration subsystem 260 may also set or calibrate the reading parameters of the RFID readers based on the index for at least one category of the matrix of experiments. The calibration subsystem 260, therefore, calibrates the RFID readers to enhance a read capability (e.g. increase a sensitivity of the RFID reader) thereof for reading the RFID tags.

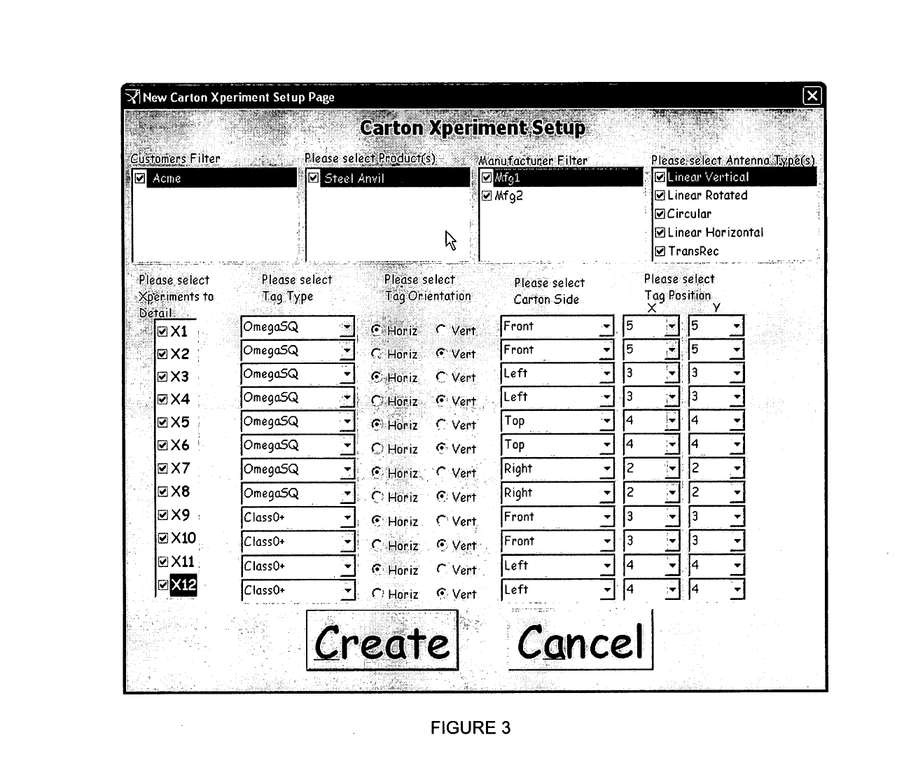

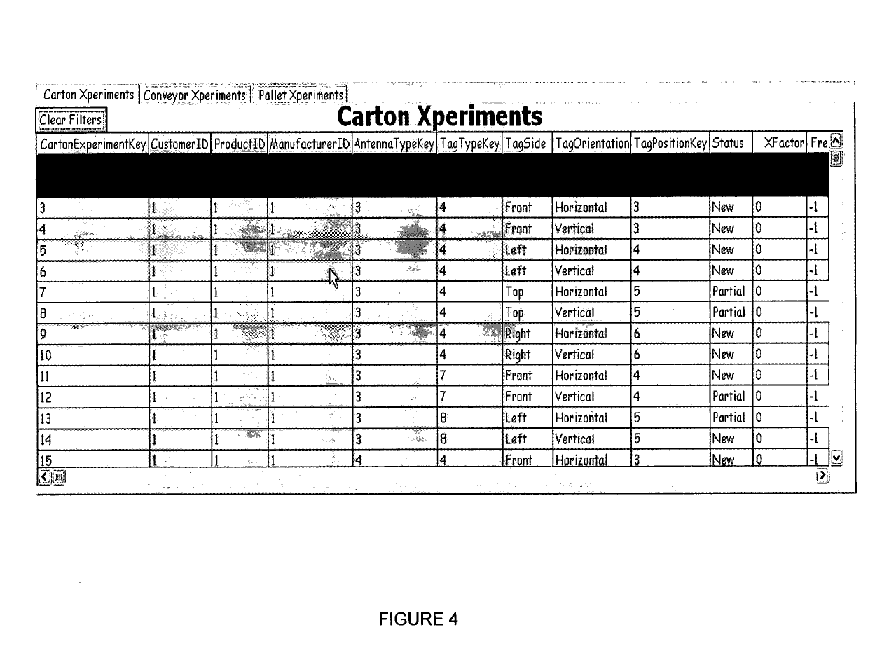

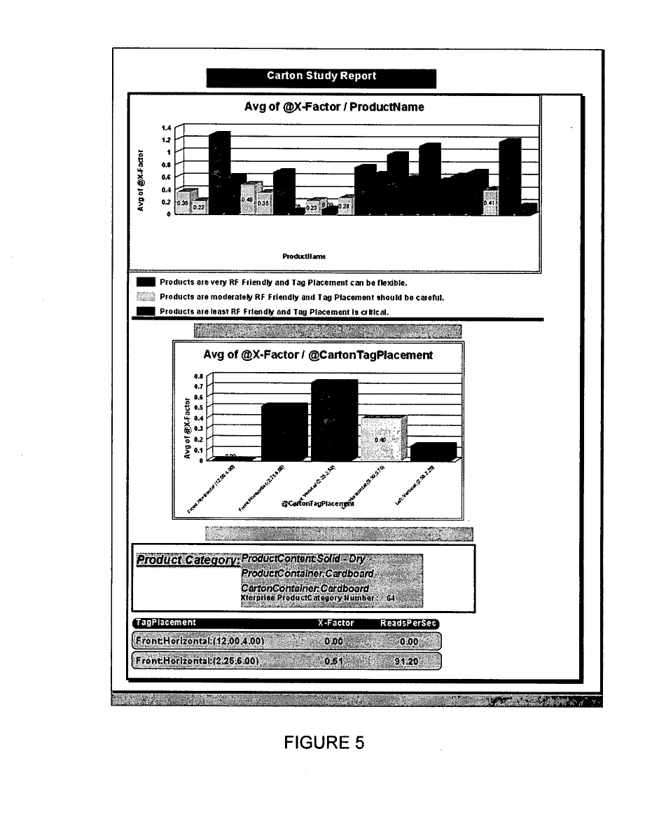

Turning now to FIGS. 3 to 5, illustrated are screen shots demonstrating a method of ranking a likelihood of success of reading RFID tags on a product in accordance with the principles of the present invention. More specifically, FIG. 3 illustrates a design of experiments setup menu wherein a user configures the RFID-detect ranking system to build a matrix of experiments to be tested. FIG. 4 illustrates a view of the experiments including a status thereof indicated by “Done,” “New,” and “Partial.” FIG. 5 illustrates a screen shot demonstrating a method of ranking a likelihood of success of reading RFID tags on a product.

Assume a test on two products with two types of RFID tags, two different RFID tag orientations and one RFID tag location. This example yields eight different experiments for ranking the likelihood of success of reading the RFID tags (i.e., two products by two RFID tag types by two RFID tag orientations by one RFID tag location). A matrix of experiments may be constructed as set forth below in TABLE 1 employing a setup menu (referred to as a Carton Xperiment™ Setup) illustrated with respect to FIG. 3. The setup menu illustrates an experiment for a single product with five different antenna options and 12 different RFID tag positions, causing 60 experiments to be created. With a manual data capture, the 60 experiments would take roughly 30 days, not including any reporting, nor guaranteeing any range of accuracy. With the RFID-detect ranking system, the average time for such an experiment is a fraction of the time yielding accurate data with automatic data capture.

TABLE 1

| | | RFID TAG | RFID TAG |
|---|---|---|---|
| PRODUCT | RFID TAG TYPE | LOCATION | ORIENTATION |
| SKU A | Squiggle | (9, 4.25) | Horizontal |
| SKU A | Squiggle | (9, 4.25) | Vertical |
| SKU A | M Tag | (9, 4.25) | Horizontal |
| SKU A | M Tag | (9, 4.25) | Vertical |
| SKU B | Squiggle | (9, 4.25) | Horizontal |
| SKU B | Squiggle | (9, 4.25) | Vertical |
| SKU B | M Tag | (9, 4.25) | Horizontal |
| SKU B | M Tag | (9, 4.25) | Vertical |

As more variables (consistent with Taguchi's orthogonal arrays) are added with several options for each array, the number of experiments can grow geometrically. In addition to the increase of creating the experiments, capturing trial data for each experiment is more substantial. In order to capture statistical information (e.g., mean, standard deviation, confidence intervals) in normal distributions, it is preferable that at least 33 trials are captured for each category of experiment. In the instant case, the RFID-detect ranking subsystem captures at least 35 trials per experiment for a safety margin and may be configured to capture as many trials as desired.

For the above example of eight experiments, there are 280 data captures (i.e., 8×35) to complete the experiments. For any actual application, potentially several thousand data captures may typically be necessary. The initial design of an experiment displays the appropriate variables with multiple options so the experiments are created mathematically and stored into a database. This logged data facilitates accurate experimental history while also maintaining current status and an accurate automatic update capability for the completed experiments.

In accordance with the RFID-detect ranking system, a user can also visually see experiments in all stages of completion, from pending to completed, with a coded (e.g., color coded) graphical system as illustrated with respect to FIG. 4. Again, the status field of the graphical system provides a status of the various experiments. From this point, a user can accurately filter down to the current experiment and then capture the data automatically and directly from the RFID reader itself, removing human error during the collection process. The application receives the information from the RFID reader directly and more efficiently than manual capture reducing the overall time for each experiment and dramatically increasing productivity.

Another benefit associated with the RFID-detect ranking system lies within the data itself and its accuracy when repeated. Previously, the personnel performing the experiment could accidentally and unknowingly corrupt the experiment. When the same experiment was repeated, drastically different results were often recorded with resulting ambiguous and confusing deductions. The RFID-detect ranking system, however, receives very similar results regardless of how many times an experiment is repeated as the RFID reader settings are controlled and set by the RFID-detect ranking system, not the user.

The quality of RFID friendliness, a term used to describe how well a product performs with radio frequency identification, is a point of particular interest to the supply chain. After testing several products, it was evident that product contents, packaging, and orientation play an important role on how well radio frequency identification will work in accordance with a product. Extensive testing of RFID tags and RFID readers on a comprehensive sampling of products, contents, packaging and orientation may determine that products with similar contents, packaging, and orientation should react accordingly, but a quantitative scale is needed to exploit this finding. A feature of the RFID-detect ranking system adds two parameters to track and verify the aforementioned hypothesis, namely, a product category and an index. The product category (which forms part of the product information) includes three general properties and their associated relationships referred to as a product content, a product container, and a carton container, thereby forming a quantitative product category list.

As an example, if a product is a dielectric liquid inside a plastic bottle encased in a cardboard carton, then its category number would be, for instance, 31; a number predetermined by the structured relationships within the product categories. As an example, over 560 product categories have been defined, but the principles of the present invention comprehend the addition of an indeterminate number of product categories and those skilled in the art will realize that the overall concept is not specifically number dependent. An example list of product categories is provided in TABLE 2 below.

TABLE 2

| Product | Product | Carton | Product |
|---|---|---|---|
| Content | Container | Container | Category |
| Dielectric | Plastic | Cardboard | 31 |
| Dielectric | Plastic | Plastic | 32 |
| Dielectric | Plastic | Paper | 33 |
| Dielectric | Plastic | Wood | 34 |
| Dielectric | Plastic | Metal | 35 |
| Dielectric | Metal | Cardboard | 36 |
| Dielectric | Metal | Plastic | 37 |
| Dielectric | Metal | Paper | 38 |
| Dielectric | Metal | Wood | 39 |
| Dielectric | Metal | Metal | 40 |

Another part of the RFID friendliness within the RFID-detect ranking system is the index, which provides an indication of the likelihood of success that an RFID tag located on a product will be read by an RFID reader. As an example, the index provides a ratio to compare the performance of an RFID tag placed in a specific location on a product to the performance of that same RFID tag in free space (read range and all other settings are typically held constant). The RFID tag in free space may be used as a control element. At the beginning of the experiment, a free space read rate is determined and captured. During the following trials, the RFID-detect ranking system compares the read rate on the product to the free space read rate (again, the control element). The resulting ratio is defined as the index. As an example, suppose the read rate of the RFID tag on the product is 200 reads per second and the read rate of the RFID tag in air or free space is 400 reads per second. The resulting index is percentage is 50% (relating the reads per second of the RFID tag on the product divided by the reads per second of the RFID tag in free space). Stated another way, the RFID friendliness of the RFID tag on the product is 50% as friendly as the RFID tag in free space. With each product category assigned within a database, the RFID-detect ranking system can automatically compile the index for the categories and additionally compile the RFID friendliness information into a comprehensive record.

Following the data capture, the RFID-detect ranking system converts the data into the index to provide useful information and includes a built-in and automatic reporting structure. Thus, the collected experimental data is processed, sorted, and rationalized into easy-to-read formats and graphical representations so that customers can understand the results quickly and easily. Before the introduction of the RFID-detect ranking system with the reporting modules, human tuning and manual data manipulation (spreadsheets) required several hours to make sense of the literally thousands of trials. The data had to be calculated through several iterations and mathematical interpretations so that the resulting data became something tangible and useful.

An exemplary graphical representation of a report associated with a reporting module in accordance with the RFID-detect ranking system is illustrated with respect to FIG. 5. The reporting module provides different values based on the type of experiment being performed such as, without limitation, an index for reads per second for carton studies and an index for reads per pass for conveyor and pallet studies. The values are calculated within the RFID-detect ranking system and the reporting module prepares a report in the form of, for instance, a graphical representation, so that the differences are more apparent to the end user.

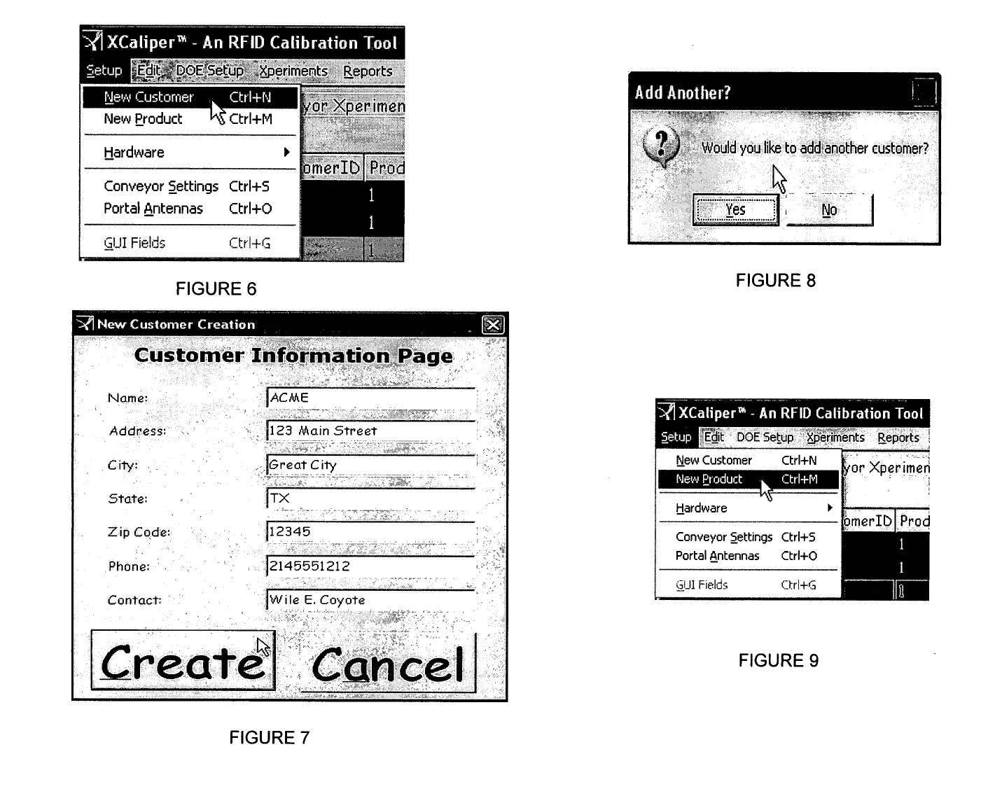

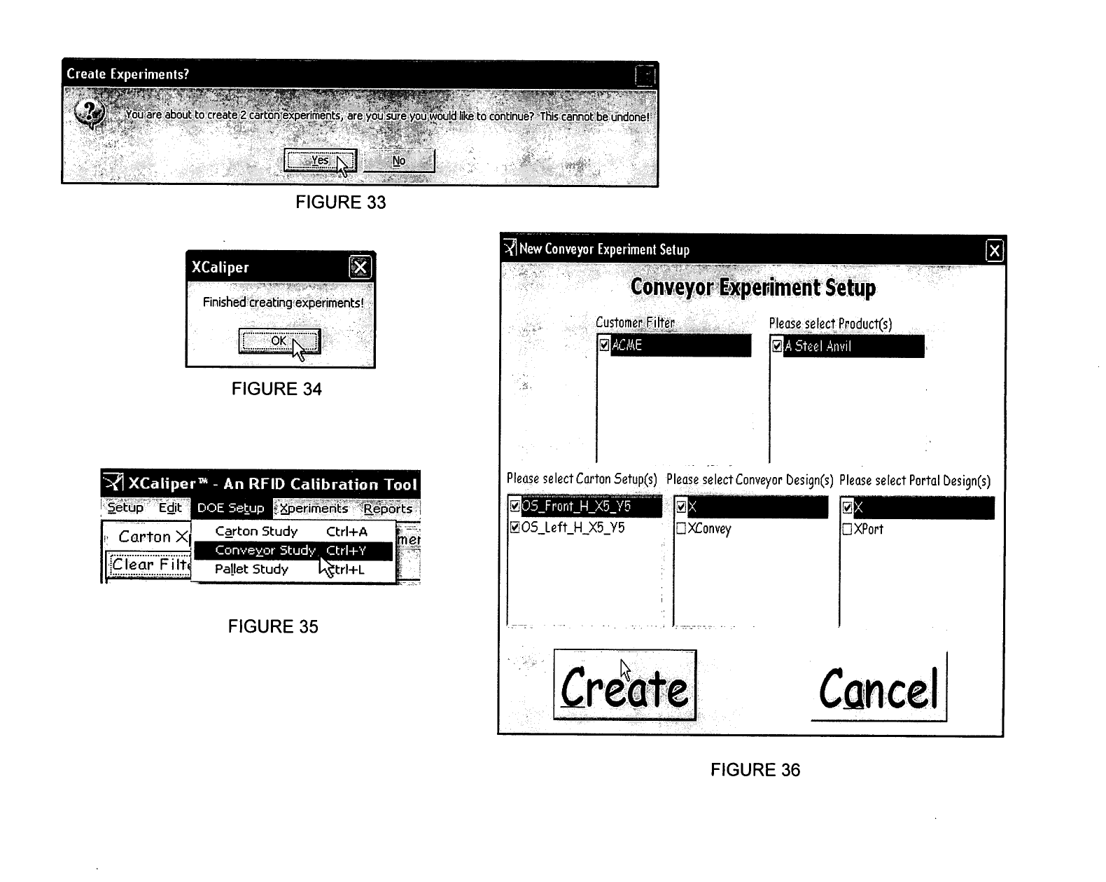

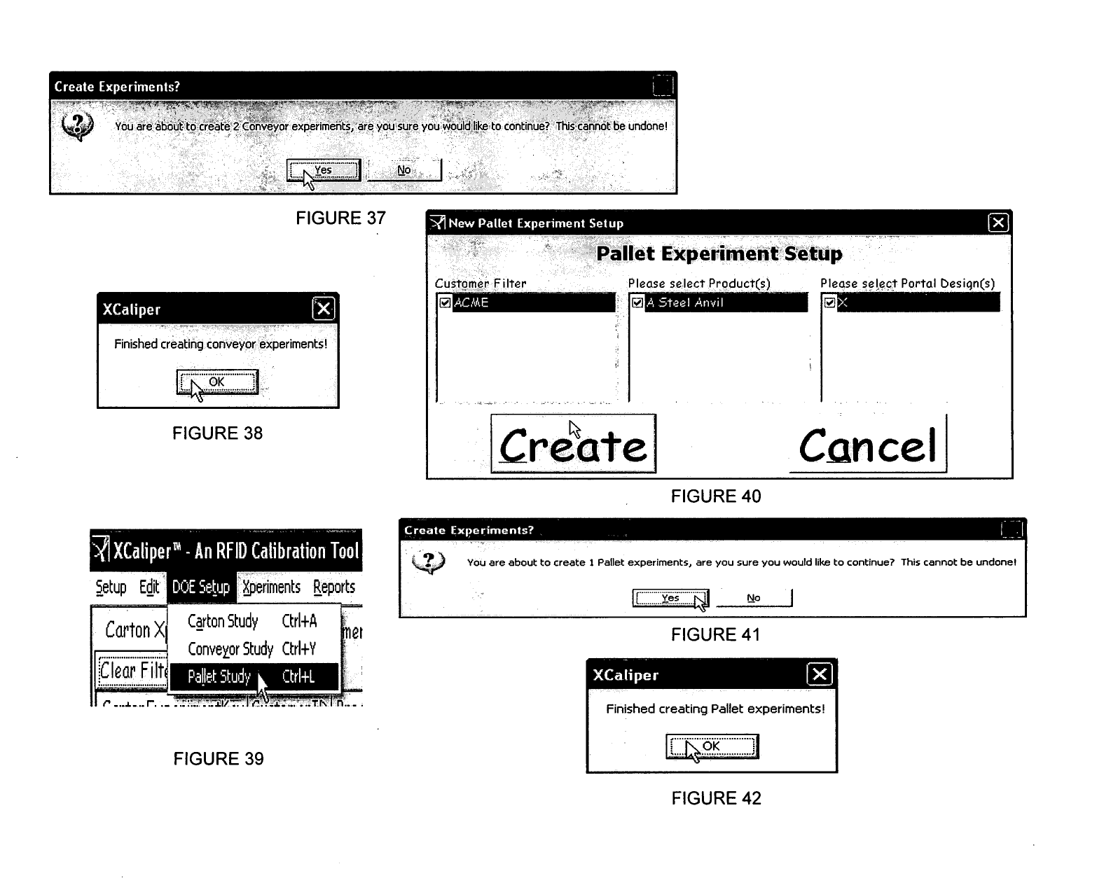

Turning now to FIGS. 6 to 61, illustrated are screen shots demonstrating a setup, design of experiments, experiment trials and reporting associated with an embodiment of an RFID-detect ranking system (again, referred to as “XCaliper™”) in accordance with the principles of the present invention. Beginning with FIG. 6, the menu option adds a new customer into a database associated with the RFID-detect ranking system. A state field may be a two digit alphanumeric character abbreviation, the zip code may be a standard five digit number and the phone number should include the area code excluding all dashes, parentheses, etc. (see FIG. 7 for an exemplary input screen). After creating a customer, the RFID-detect ranking system asks a user if another customer is to be created (see FIG. 8). If the user selects yes, the user repeats the above steps for a new customer. If the user selects no, the RFID-detect ranking system will return to an overview page. Any number of customers may be added as the experiment dictates.

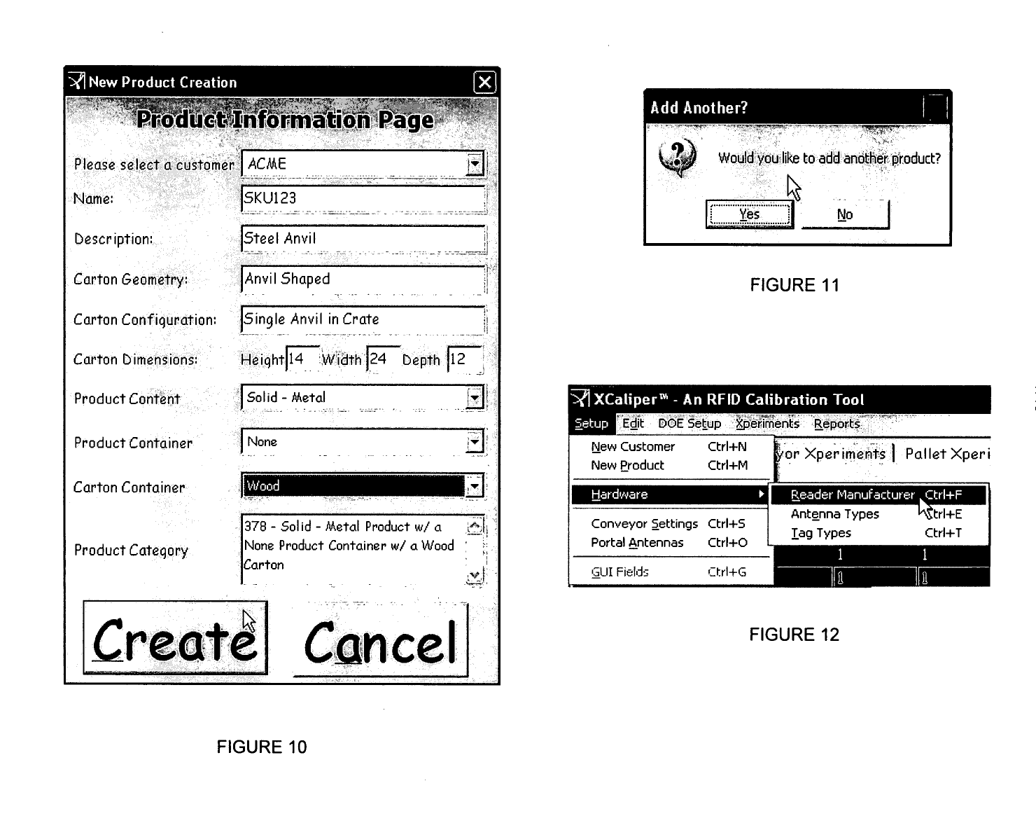

The RFID-detect ranking system continues with a menu option as illustrated in FIG. 9 that adds a new product in the database linked to an existing customer. The product name should be a unique name or number (usually a stock keeping unit designated “SKU”) and a brief description thereof. The description should include geometric information providing the product's inner geometric shape (e.g., square, cylinder, egg-shaped). A configuration of the product should describe how the inner shapes are packed together (e.g., stacked, linear) and the dimensions thereof, preferably in inches. The content, product container, and carton container should be selected so that a product category can be assigned (see FIG. 10 for an exemplary input screen).

After adding a product to the database, the RFID-detect ranking system asks the user if another product should be added to the database (see FIG. 11). If the user selects yes, the user repeats the aforementioned steps for a new product. If the user selects no, the RFID-detect ranking system will return to the overview page. Any number of products may be added as the experiment dictates.

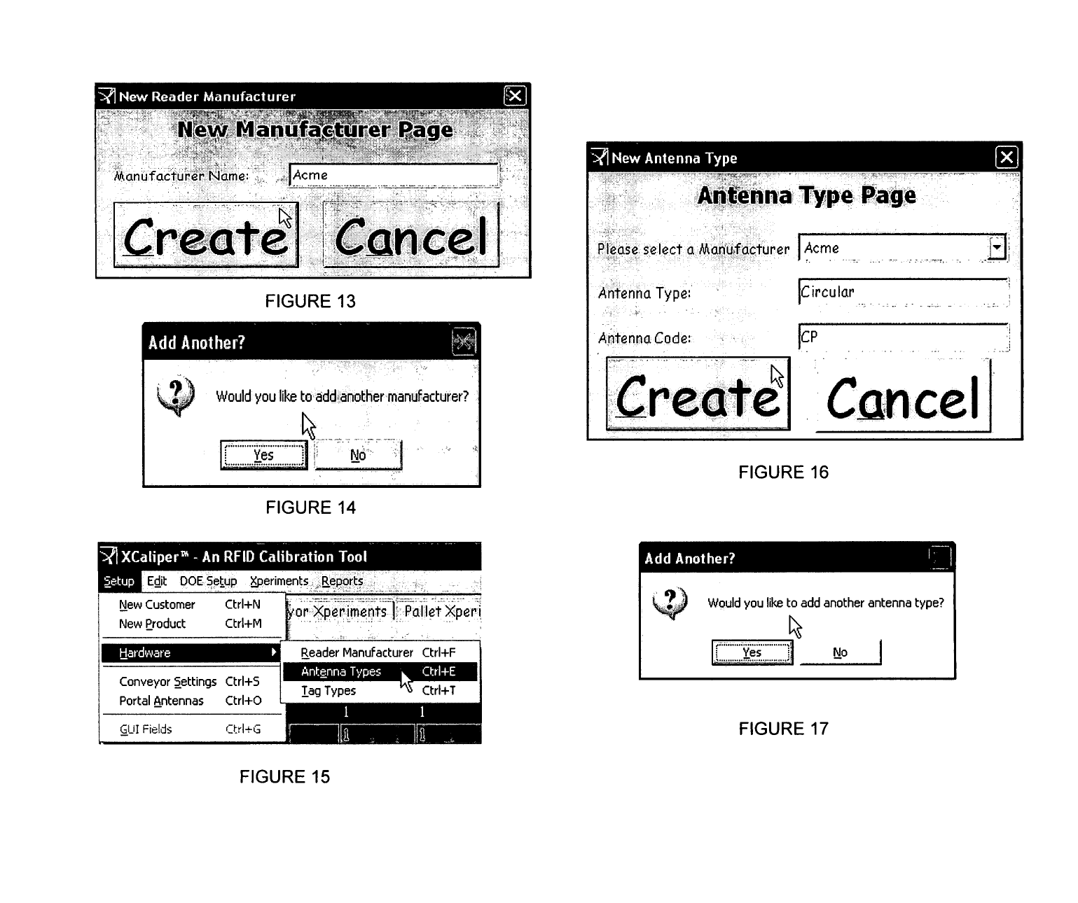

The RFID-detect ranking system continues with a menu option as illustrated in FIG. 12 that adds a manufacturer of RFID readers to the database (see FIG. 13 for an exemplary input screen). After adding a manufacturer to the database, the RFID-detect ranking system asks the user if another manufacturer should be added to the database (see FIG. 14). If the user selects yes, the user repeats the aforementioned steps for a new manufacturer. If the user selects no, the RFID-detect ranking system will return to the overview page. Any number of manufacturers may be added as the experiment dictates.

The RFID-detect ranking system continues with a menu option as illustrated in FIG. 15 that adds an antenna type associated with a manufacturer of an RFID reader to the database (see FIG. 16 for an exemplary input screen). A two digit alphanumeric character short code can be specified as well. After adding an antenna type to the database, the RFID-detect ranking system asks the user if another antenna type should be added to the database (see FIG. 17). If the user selects yes, the user repeats the aforementioned steps for a new antenna type. If the user selects no, the RFID-detect ranking system will return to the overview page. Any number of antenna types may be added as the experiment dictates.

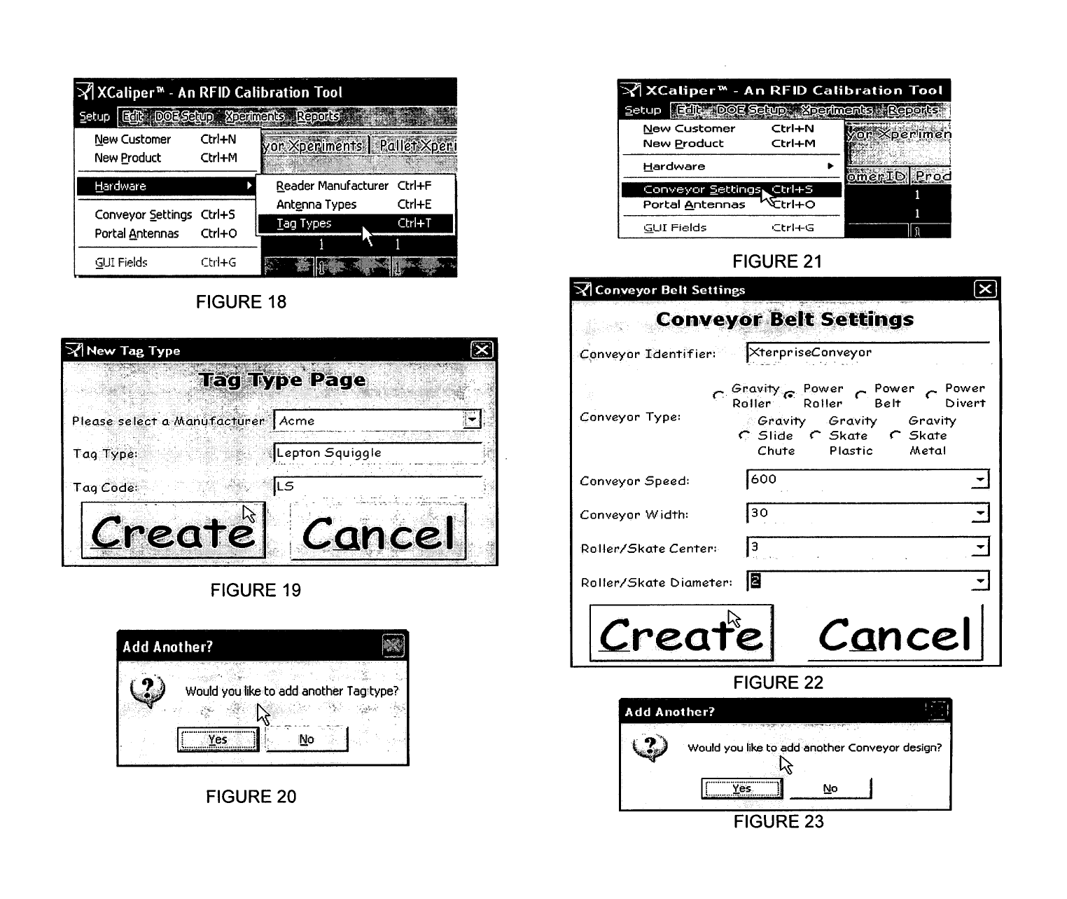

The RFID-detect ranking system continues with a menu option as illustrated in FIG. 18 that adds an RFID tag type associated with a manufacturer of an RFID reader to the database (see FIG. 19 for an exemplary input screen). A two digit alphanumeric character RFID tag code can be specified as well. After adding an RFID tag type to the database, the RFID-detect ranking system asks the user if another RFID tag type should be added to the database (see FIG. 20). If the user selects yes, the user repeats the aforementioned steps for a new RFID tag type. If the user selects no, the RFID-detect ranking system will return to the overview page. Any number of RFID tag types may be added as the experiment dictates.

The RFID-detect ranking system continues with a menu option as illustrated in FIG. 21 that adds a conveyer type to the database (see FIG. 22 for an exemplary input screen). A conveyor identifier provides the conveyor settings to be stored in the database and the RFID-detect ranking system may provide a list of conveyer setup options as well. It should be understood that the RFID-detect ranking system may provide a list of options for any menu associated therewith. Typical parameters for the conveyor include conveyer speed (in feet per minute), conveyor width (in inches), a roller/skate center (a distance in inches between the roller centers) and a roller/skate diameter (a measurement in inches of the cylinder or skate/roller diameter). Of course, the broad scope of the present invention is not limited to the aforementioned parameters or units of measure.

After adding a conveyer type to the database, the RFID-detect ranking system asks the user if another conveyer type should be added to the database (see FIG. 23). If the user selects yes, the user repeats the aforementioned steps for a new conveyer type. If the user selects no, the RFID-detect ranking system will return to the overview page. Any number of conveyer types may be added as the experiment dictates.

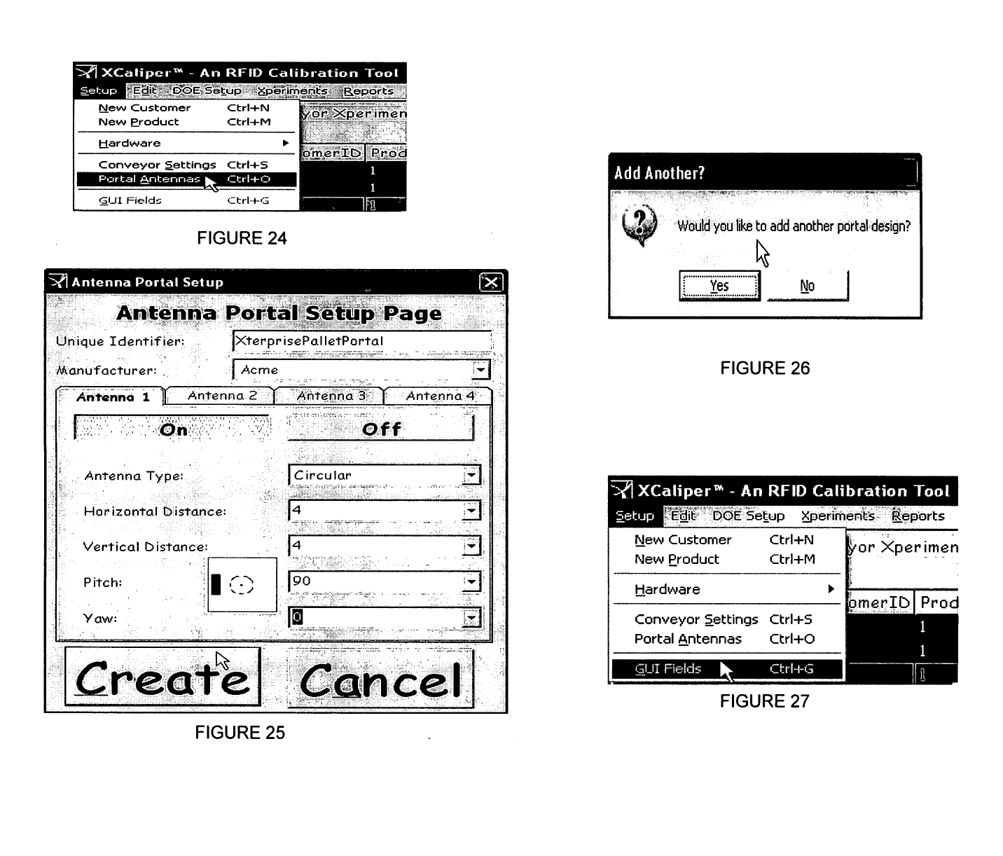

The RFID-detect ranking system continues with a menu option as illustrated in FIG. 24 that adds an antenna portal design to the database (see FIG. 25 for an exemplary input screen). The fields associated with this menu option should be populated when an antenna is set to “on.” The antenna portal is assigned a portal identifier and a manufacturer of the antennas is associated with the antenna portal. A user can then select the antennas (in this case four antennas) individually and edit the properties thereof. When the antennas are “on,” the user can select the antenna from a list of options. Also, as the user decides in the experiment, any antenna may be turned off to isolate the design of the antenna portal to any number of antennas.

Several parameters contribute to a makeup of the antennas such as the horizontal and vertical distances (e.g., measured in feet) that correspond to a distance from the antenna to the center of the antenna portal. A pitch determines at what vertical angle the antenna is located in degrees relative to the floor with the user standing behind the antenna. A diagram of the antenna portal has an indicator representing material flow coming toward the user (i.e., out of a page/screen) when looking at the antenna portal. When a degree/vertical angle is selected, a graphic displays a view for the benefit of the user. Yaw is the horizontal pivot of the antenna (left or right when standing behind the antenna), if any, in degrees and the user may employ a positive or negative adjustment for a right and left adjustment, respectively. For example, if the user wants to angle the antenna toward an exit side (out of the page/screen) of the antenna portal (the right side if standing behind antenna 1), then the user specifies the angle in positive degrees.

After adding an antenna portal to the database, the RFID-detect ranking system asks the user if another antenna portal should be added to the database (see FIG. 26). If the user selects yes, the user repeats the aforementioned steps for a new antenna portal. If the user selects no, the RFID-detect ranking system will return to the overview page. Any number of antenna portals may be added as the experiment dictates.

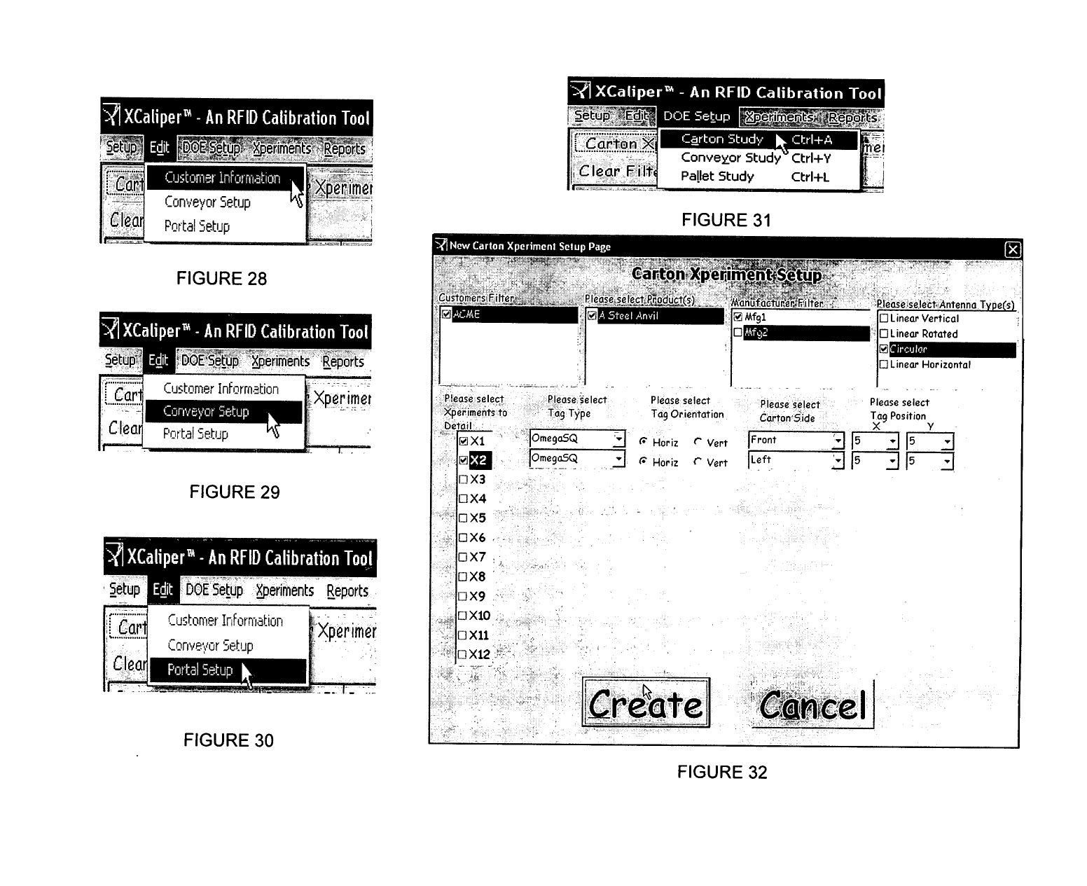

The RFID-detect ranking system continues with a menu option as illustrated in FIG. 27 that adds graphical user interface functionality thereto. The RFID-detect ranking system thereafter provides menu options to edit information about a customer (see FIG. 28), information about a conveyer type (see FIG. 29) and information about an antenna portal (see FIG. 30), to name a few.

The RFID-detect ranking system continues with a menu option as illustrated in FIGS. 31 to 34 directed to a design of experiments for a product study such as a carton study (including a “Carton Xperiment Setup”). A customer filter adds products to a list as users select customers, and removes products from the list as users uncheck customers. A manufacturer filter functions the same way as the customer filter with respect to the RFID tag type and the antenna portal. The remainder of the fields may be filled according to an RFID engineering design.

The RFID-detect ranking system continues with a menu option as illustrated in FIGS. 35 to 38 directed to a design of experiments for a conveyer study (including a “Conveyer Experiment Setup”). A customer filter adds products to a list as users select customers, and removes products from the list as users uncheck customers. As products are selected, the resulting carton studies that are completed are added to a carton setup list. The conveyer type and antenna portal design fields may be filled according to an RFID engineering design.

The RFID-detect ranking system continues with a menu option as illustrated in FIGS. 39 to 42 directed to a design of experiments for a pallet study (including a “Pallet Experiment Setup”). A customer filter adds products to a list as users select customers, and removes products from the list as users uncheck customers. Again, the antenna portal design field may be filled according to an RFID engineering design.

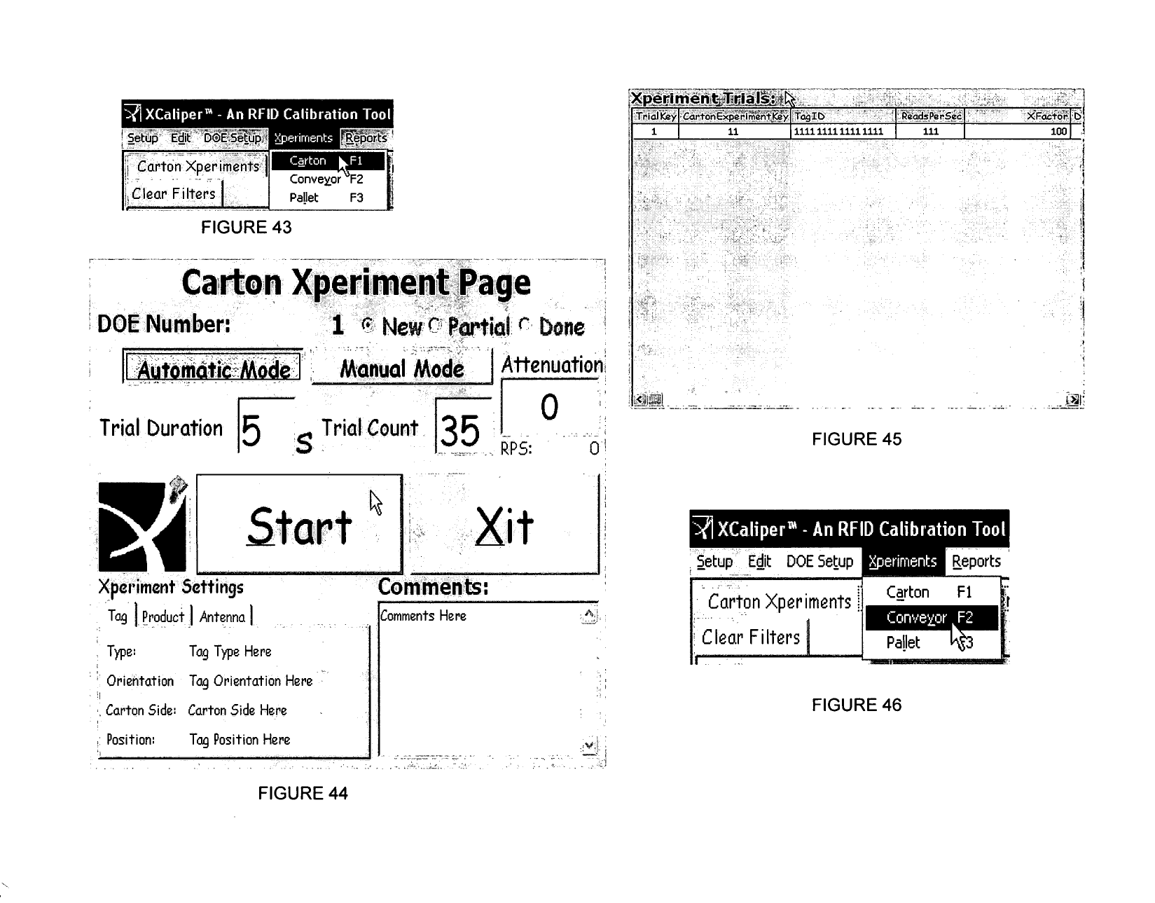

After the setup is complete and the design of experiments created, the RFID-detect ranking system performs experiments as illustrated with respect to FIGS. 43 to 53. The menu option and subsequent experiment for a carton is illustrated with respect to FIGS. 43 to 45 (including a “Carton Xperiment Page”). At any time, an exit button (referred to as “Xit”) may be selected to exit the experiment and return to an overview page. The user may select either an automatic mode or manual mode of operation by selecting the option, of which an automatic mode of operation has been selected herein. With automatic mode of operation, the user inputs a duration for each trial in the experiment, as well as the total number of trials desired. The details about the experiment are displayed in the tabbed area titled “Xperiment Settings.” Once the settings are verified, the data may be collected by selecting the “Start” button. As data is collected, the results are appended to an output window as illustrated with respect to FIG. 45.

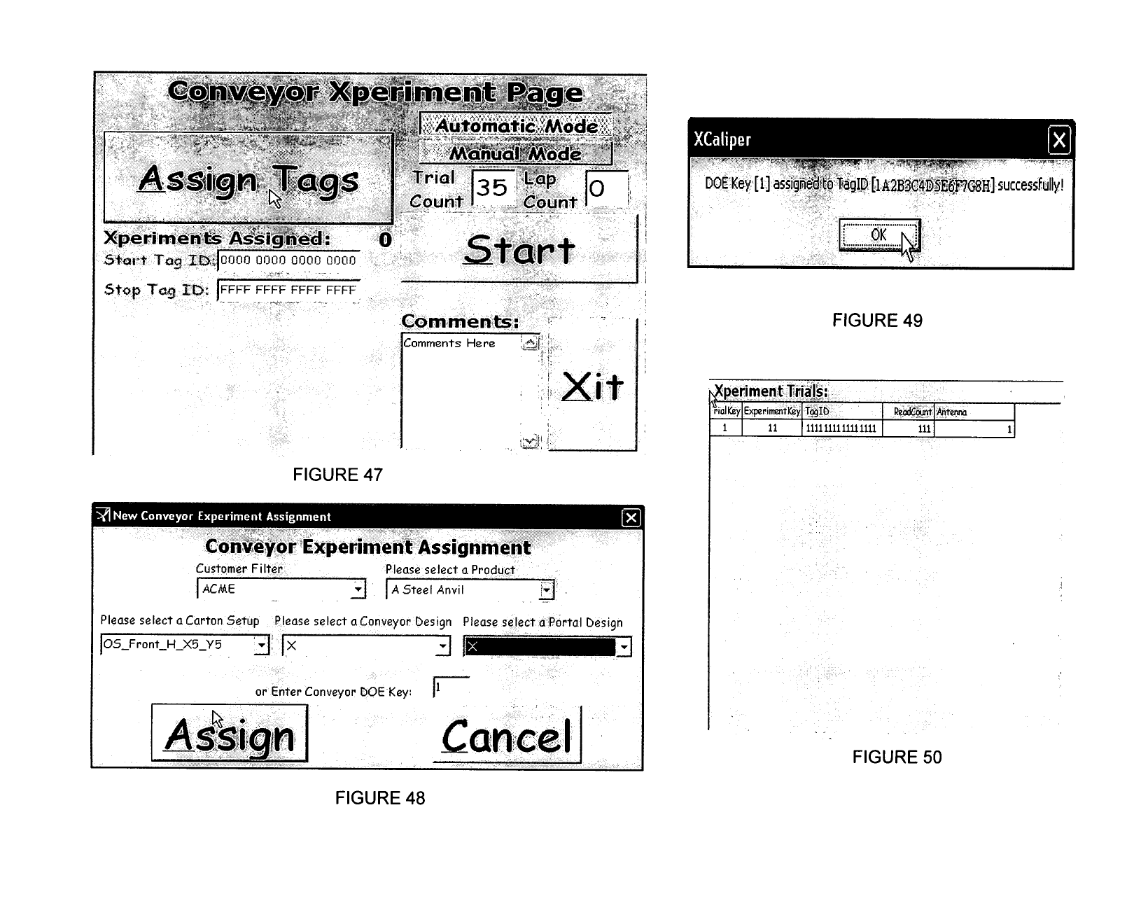

The menu option and subsequent experiment for a conveyer is illustrated with respect to FIGS. 46 to 50 (including a “Conveyer Xperiment Page”). At any time, an exit button (referred to as “Xit”) may be selected to exit the experiment and return to an overview page. The user may select either an automatic mode or manual mode of operation by selecting the option, of which an automatic mode of operation has been selected herein. With automatic mode of operation, the user assigns RFID tags to each conveyer experiment (see FIGS. 47 and 48). FIG. 49 illustrates a message when the assignment of the RFID tag has been completed correctly. Similar messages may instruct the user if an error has occurred. Once the RFID tags are assigned, the data may be collected by selecting the “Start” button. As data is collected, the results are appended to an output window as illustrated with respect to FIG. 50.

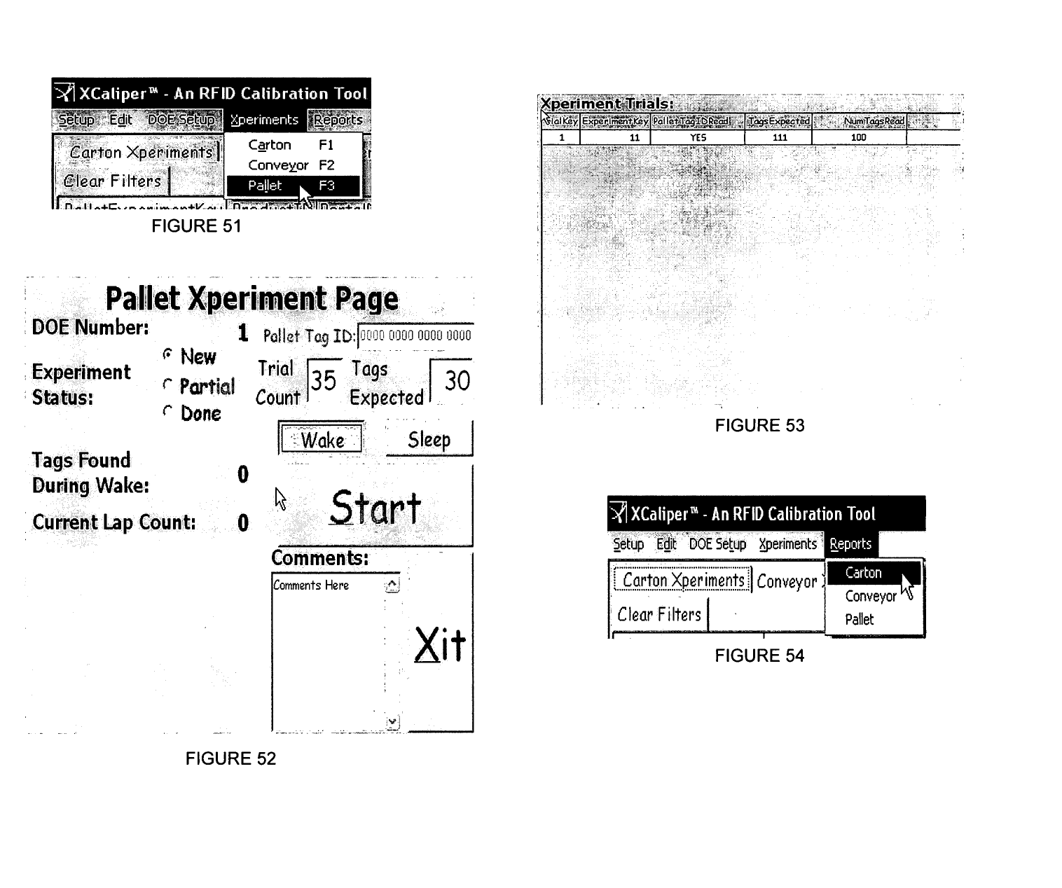

The menu option and subsequent experiment for a pallet is illustrated with respect to FIGS. 51 to 53 (including a “Pallet Xperiment Page”). At any time, an exit button (referred to as “Xit”) may be selected to exit the experiment and return to an overview page. The pallet experiment takes place in two stages, namely, a wake stage and a sleep stage. Once the wake stage is selected (see FIG. 52), the experiment begins by selecting the “Start” button, which will transition to a “Stop” button when the wake stage is complete. After the user presses the “Stop” button, the sleep stage is automatically activated. The user will then press the “Start” button to acquire the experiment data. As data is collected, the results are appended to an output window as illustrated with respect to FIG. 53. The aforementioned process continues until the experiments are complete.

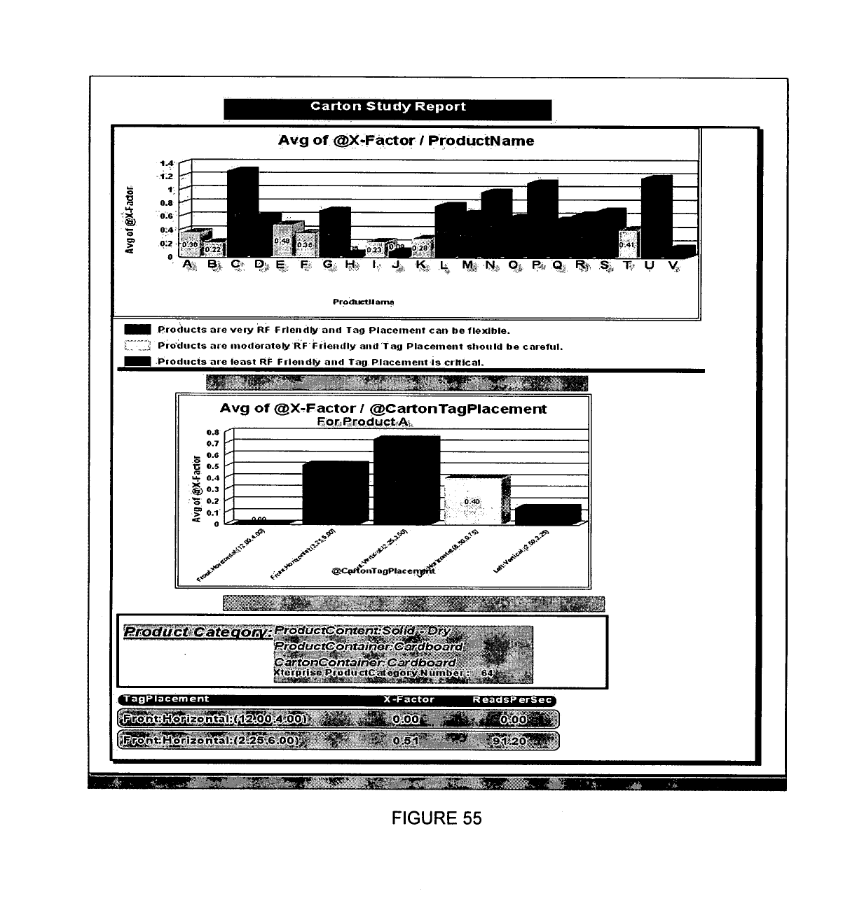

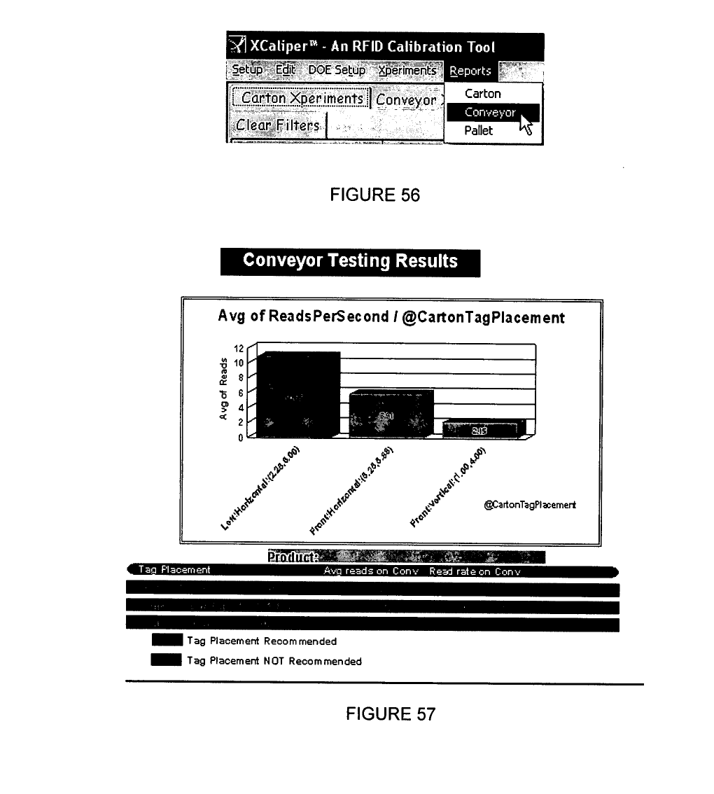

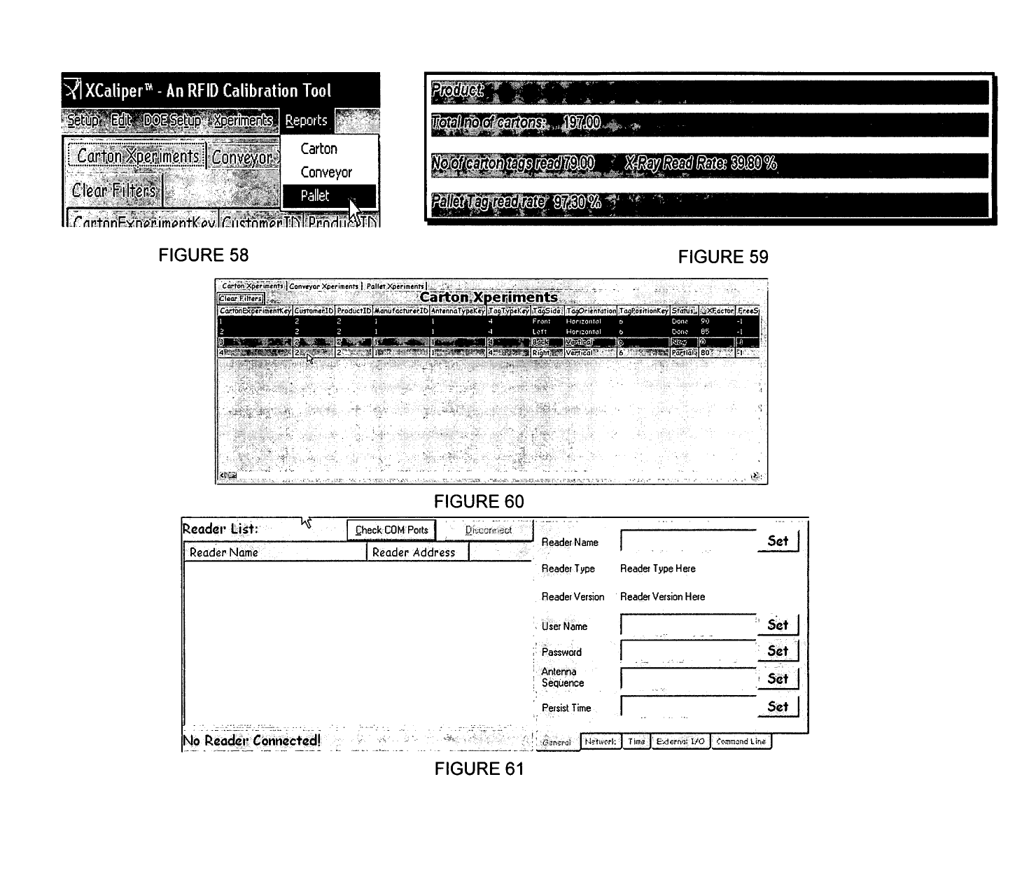

The RFID-detect ranking system thereafter provides menu options to provide automatic reporting modules for cartons (see FIGS. 54 and 55), conveyors (see FIGS. 56 and 57) and pallets (see FIGS. 58 and 59), to name a few. FIG. 60 illustrates an exemplary experiment pane (referred to as “Carton Xperiments”), which may be used to filter experiments, transfer to experiments, or simply provide information of what resides in a database of the RFID-detect ranking system. FIG. 61 illustrates an exemplary reader pane employable to monitor, connect, and edit available RFID readers. The reader list category maintains a dynamic list of RFID readers, and serial RFID readers may be polled by selecting the “Check COM Ports” button. The reader status bar displays relevant messages to the user about the reader pane. The reader pane includes reader tabs with a general tab that displays general information about the currently connected RFID reader. A network tab displays network information about the currently connected RFID reader. The time tab displays time information about the currently connected RFID reader. The external I/O tab displays external I/O information about the currently connected RFID reader. A command line allows the user a command line function to the currently connected RFID reader.

For a better understanding of RFID technologies, in general, see “RFID Handbook,”by Klaus Finkenzeller, published by John Wiley & Sons, Ltd., 2^{nd} edition (2003), which is incorporated herein by reference. For a better understanding of RFID tags in compliance with the EPC, see “Technical Report 860 MHz-930 MHz Class I Radio Frequency Identification Tag Radio Frequency & Logical Communication Interface Specification Candidate Recommendation,” Version 1.0.1, November 2002, promulgated by the Auto-ID Center, Massachusetts Institute of Technology, 77 Massachusetts Avenue, Bldg 3-449, Cambridge Mass. 02139-4307, which is incorporated herein by reference. For a better understanding of conventional RFID readers, see the following RFID readers, namely, “MP9320 UHF Long-Range Reader” provided by SAMSys Technologies, Inc. of Ontario, Canada, “MR-1824 Sentinel-Prox Medium Range Reader” by Applied Wireless ID of Monsey, N.Y. (see also U.S. Pat. No. 5,594,384 entitled “Enhanced Peak Detector,” U.S. Pat. No. 6,377,176 entitled “Metal Compensated Radio Frequency Identification Reader,” U.S. Pat. No. 6,307,517 entitled “Metal Compensated Radio Frequency Identification Reader”), “2100 UAP Reader,” provided by Intermec Technologies Corporation of Everett, Wash. and “ALR-9780 Reader,”provided by Alien Technology Corporation of Morgan Hill, Calif. The aforementioned references, and all references herein, are incorporated herein by reference in their entirety.

Also, although the present invention and its advantages have been described in detail, it should be understood that various changes, substitutions and alterations can be made herein without departing from the spirit and scope of the invention as defined by the appended claims. For example, many of the systems, subsystems and methodologies discussed above can be implemented in different methodologies and replaced by other related systems and subsystems, or a combination thereof, to advantageously form an RFID-detect ranking system as described herein.

Moreover, the scope of the present application is not intended to be limited to the particular embodiments of the process, machine, manufacture, composition of matter, means, methods and steps described in the specification. As one of ordinary skilled in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A radio frequency identification (RFID)-detect ranking system, comprising:
a matrix subsystem configured to construct a matrix of experiments based on product information, RFID reader information and RFID tag information;
a data collection subsystem configured to facilitate an experiment and collect data to fill in results for each category of said matrix of experiments; and
a ranking subsystem configured to assign an index based on said results for each category of said matrix of experiments, thereby providing a likelihood of success of reading an RFID tag located on a product with an RFID reader.

2. The RFID-detect ranking system as recited in claim 1 wherein said product information is selected from the group consisting of:
type of product,
product configuration, and
product make-up.

3. The RFID-detect ranking system as recited in claim 1 wherein said RFID reader information is selected from the group consisting of:
type and design of said RFID reader,
sensitivity of said RFID reader, and
configuration of said RFID reader.

4. The RFID-detect ranking system as recited in claim 1 wherein said RFID tag information is selected from the group consisting of:
type and design of said RFID tag,
configuration of said RFID tag,
orientation of said RFID tag,
placement position of said RFID tag, and
read range of said RFID tag.

5. The RFID-detect ranking system as recited in claim 1 further comprising a calibration subsystem configured to set reading parameters of said RFID reader.

6. The RFID-detect ranking system as recited in claim 1 further comprising a reporting module configured to provide a report to display said index for each category of said matrix of experiments in a user-friendly format.

7. The RFID-detect ranking system as recited in claim 1 wherein said matrix subsystem is further configured to construct said matrix of experiments based on at least one of environmental conditions, conveyer designs and antenna portal designs.

8. The RFID-detect ranking system as recited in claim 1 wherein said data collection subsystem is configured to facilitate a plurality of experiments.

9. The RFID-detect ranking system as recited in claim 1 further comprising a database configured to store at least one of said product information, said RFID reader information and said RFID tag information.

10. The RFID-detect ranking system as recited in claim 1 wherein said index provides a read rate of said RFID tag on said product with said RFID reader in comparison to a free space read rate of said RFID tag with said RFID reader.

11. A method for providing a likelihood of reading a radio frequency identification (RFID) tag, comprising:
constructing a matrix of experiments based on product information, RFID reader information and RFID tag information;
facilitating an experiment;
collecting data to fill in results for each category of said matrix of experiments; and
assigning an index based on said results for each category of said matrix of experiments, thereby providing a likelihood of success of reading an RFID tag located on a product with an RFID reader.

12. The method as recited in claim 11 wherein said product information is selected from the group consisting of:
type of product,
product configuration, and
product make-up.

13. The method as recited in claim 11 wherein said RFID reader information is selected from the group consisting of:
type and design of said RFID reader,
sensitivity of said RFID reader, and
configuration of said RFID reader.

14. The method as recited in claim 11 wherein said RFID tag information is selected from the group consisting of:
type and design of said RFID tag,
configuration of said RFID tag,
orientation of said RFID tag,
placement position of said RFID tag, and
read range of said RFID tag.

15. The method as recited in claim 11 further comprising setting reading parameters of said RFID reader.

16. The method as recited in claim 11 further comprising providing a report to display said index for each category of said matrix of experiments in a user-friendly format.

17. The method as recited in claim 11 wherein said constructing further includes constructing said matrix of experiments based on at least one of environmental conditions, conveyer designs and antenna portal designs.

18. The method as recited in claim 11 wherein said facilitating further comprises facilitating a plurality of experiments.

19. The method as recited in claim 11 further comprising storing at least one of said product information, said RFID reader information and said RFID tag information.

20. The method as recited in claim 11 wherein said index provides a read rate of said RFID tag on said product with said RFID reader in comparison to a free space read rate of said RFID tag with said RFID reader.
